(19) United States
(12) Patent Application Publication
(10) Pub. No.: US 2022/0003178 A1
(43) Pub. Date: Jan. 6, 2022

(54) ENGINE SYSTEM

(71) Applicant: Mazda Motor Corporation, Aki-gun (JP)

(72) Inventors: Takeshi Nagasawa, Aki-gun (JP); Ryo Kiyosue, Aki-gun (JP)

(21) Appl. No.: 17/346,932

(22) Filed: Jun. 14, 2021

(30) Foreign Application Priority Data
Jul. 1, 2020 (JP) 2020-113903

(51) Int. Cl. F02D 41/00; F02B 47/02

(52) U.S. Cl. CPC F02D 41/0025; F02D 2250/36; F02D 2200/602; F02B 47/02

(57) ABSTRACT

An engine system includes an engine, a water injection device that injects heated water into a combustion chamber, an accelerator position sensor that detects the accelerator position, and a controller that controls the water injection device so as to inject water into the combustion chamber during a compression stroke. The controller obtains a requested torque to be applied to the vehicle based on the accelerator position, obtains the requested engine load that is the load of the engine corresponding to the requested torque, and controls the water injection device so as to make the water injection amount when the requested engine load is in a first load region smaller than the water injection amount when the requested engine load is in a second load region in which the requested engine load is smaller than in the first load region.

### TECHNICAL FIELD

The present invention relates to an engine system that injects water into the combustion chamber of an engine.

### BACKGROUND ART

This type of technique is disclosed in, for example, JP-2009-168039A. Specifically, JP-2009-168039A discloses the technique that injects heated water (specifically, subcritical water at 250° C. or higher and 10 MPa or higher) into the combustion chamber during the compression stroke in a compression ignition engine that burns an air-fuel mixture by compression ignition. The improvement (reduction in NOₓ and CO emission amounts) of emissions and the enhancement of engine efficiency are performed by injecting water into the combustion chamber in this way.

### SUMMARY OF THE INVENTION

### Problem to be Solved by the Invention

The inventors of the present application have found that injection of water into the combustion chamber during operation of an engine under a relatively high load may cause abnormal combustion such as pre-ignition. That is, although the temperature inside the cylinder of the engine becomes high under a relatively high load, if water is injected during the compression stroke at this time, the cylinder pressure significantly rises due to the water having vaporized and expanded by the temperature rise, thereby causing abnormal combustion.

The present invention addresses the above problem of the prior art with an object of providing an engine system that can appropriately suppress abnormal combustion generated by injecting water into the combustion chamber when the engine load is relatively high.

### Means for Solving the Problem

To achieve the object described above, according to the present invention, there is provided an engine system including an engine that generates power for a vehicle by burning an air-fuel mixture including air and fuel; a water injection device that injects heated water into a combustion chamber of the engine; an accelerator position sensor that detects an accelerator position corresponding to an operation amount of an accelerator pedal of the vehicle; and a controller configured to control the water injection device so as to inject water into the combustion chamber during a compression stroke of the engine, in which the controller obtains a requested torque to be applied to the vehicle based on the accelerator position detected by the accelerator position sensor, obtains a requested engine load that is a load of the engine corresponding to the requested torque, and controls the water injection device so as to make a water injection amount when the requested engine load is in a first load region smaller than the water injection amount when the requested engine load is in a second load region in which the requested engine load is smaller than in the first load region.

According to the present invention configured as described above, since the controller sets the water injection amount when the requested engine load is in the first load region smaller than the water injection amount when the requested engine load is in the second load region, which is smaller than the first load region, it is possible to appropriately suppress abnormal combustion (such as pre-ignition) generated by injecting water into the combustion chamber when the engine load is relatively high. Specifically, reduction in the water injection amount in the first load region reduces the volume of the injected water that evaporates and expands due to a temperature rise in the cylinder and suppresses an excessive cylinder pressure rise in the compression stroke, thereby enabling suppression of abnormal combustion.

In the present invention, preferably, the controller controls the water injection device so as to make a water injection timing when the requested engine load is in the first load region more advanced than a water injection timing when the requested engine load is in the second load region.

According to the present invention configured as described above, the water injected relatively early in the compression stroke in the first load region can reach the vicinity of the cylinder liner in the combustion chamber and cool the air-fuel mixture (so-called end gas) existing in the vicinity of the cylinder liner, thereby enabling suppression of the generation of knocking and NOR. In addition, since the injected water is used for cooling, abnormal combustion due to a cylinder pressure rise caused by the expansion of water can also be suppressed.

In the present invention, preferably, the controller controls the water injection device so as to perform a plurality of water injections during the compression stroke when the requested engine load is in the first load region.

According to the present invention configured as described above, in the first load region, not only a water injection for suppressing knocking and the like, but also a water injection for improving the engine efficiency can be performed appropriately.

In the present invention, preferably, the controller controls the water injection device so as to make a timing of at least a first water injection when a plurality of water injections are performed with the requested engine load in the first load region more advanced than a water injection timing when the requested engine load is in the second load region.

According to the present invention configured as described above, by performing the first water injection relatively early in the compression stroke in the first load region, the injected water can reach the vicinity of the cylinder liner in the combustion chamber and cool the air-fuel mixture (end gas) existing in the vicinity of the cylinder liner, thereby enabling effective suppression of the generation of knocking and NOₓ.

In the present invention, preferably, when the plurality of water injections are performed with the requested engine load in the first load region, the controller controls the water injection device so as to make a water injection amount in a first half injection larger than a water injection amount in a second half injection.

According to the present invention configured as described above, by injecting a relatively large amount of water relatively early in the compression stroke in the first load region, knocking and the like can be reliably suppressed. In addition, by injecting a relatively small amount of water relatively late in the compression stroke in the first load region, engine efficiency can be improved while abnormal combustion due to an excessive cylinder pressure rise is suppressed.

In the present invention, preferably, the engine system further includes a heat exchanger that heats water using heat of exhaust gas of the engine, the heat exchanger being provided in an exhaust pipe of the engine, in which the water heated by the heat exchanger is supplied to the water injection device.

According to the present invention configured as described above, since the water injected into the combustion chamber by the water injection device is heated using the heat of exhaust gas, the exhaust heat can be recovered to improve the thermal efficiency of the engine.

To achieve the object described above, according to another aspect of the present invention, there is provided an engine system including an engine that generates power for a vehicle by burning an air-fuel mixture including air and fuel; a water injection device that injects heated water into a combustion chamber of the engine; an accelerator position sensor that detects an accelerator position corresponding to an operation amount of an accelerator pedal of the vehicle; and a controller configured to control the water injection device so as to inject water into the combustion chamber during a compression stroke of the engine, in which the controller obtains a requested torque to be applied to the vehicle based on the accelerator position detected by the accelerator position sensor, obtains a requested engine load that is a load of the engine corresponding to the requested torque, and controls the water injection device so as to make a water injection amount smaller as the requested engine load is higher.

According to the present invention configured as described above, since the water injection amount is smaller as the requested engine load is higher, abnormal combustion generated by injecting water into the combustion chamber when the engine load is relatively high can be appropriately suppressed.

### Advantage of the Invention

The engine system according to the present invention can appropriately suppress abnormal combustion generated by injecting water into the combustion chamber when the engine load is relatively high.

### BRIEF DESCRIPTION OF THE DRAWINGS

FIG. 1 is a schematic structure diagram illustrating an engine system according to an embodiment of the present invention.

FIG. 2 is a block diagram illustrating the electric structure of the engine system according to the embodiment of the present invention.

FIG. 3 is an explanatory diagram for the basic concept of a water injection control according to the embodiment of the present invention.

FIG. 4 is a flowchart illustrating the water injection control of the engine system according to the embodiment of the present invention.

FIGS. 5A and 5B are time charts for describing the operation and effect of the water injection control according to the embodiment of the present invention.

FIG. 6 is an explanatory diagram for the water injection control according to another embodiment of the present invention.

### MODES FOR CARRYING OUT THE INVENTION

Engine systems according to embodiments of the present invention will be described with reference to the attached drawings.

### Structure of Engine System

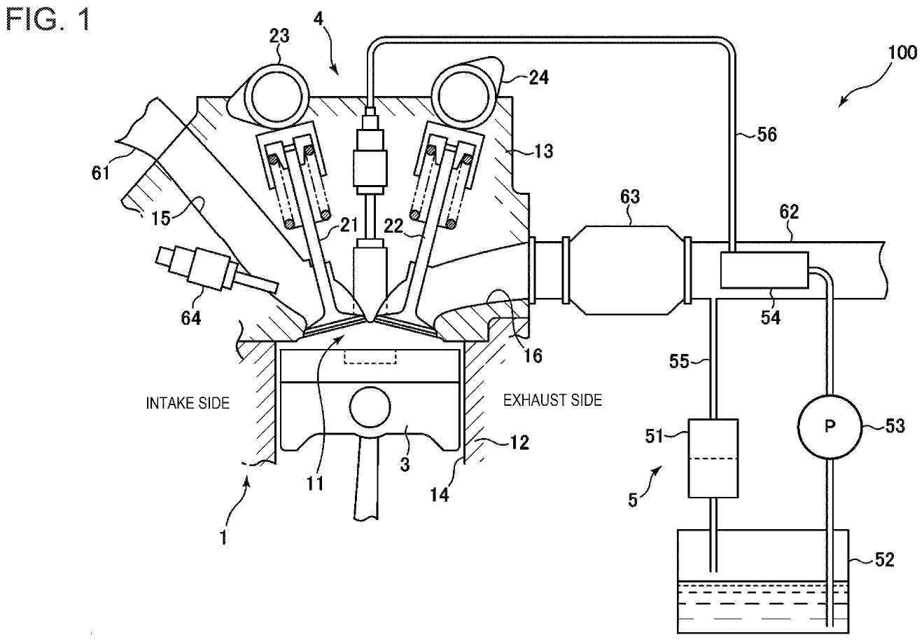

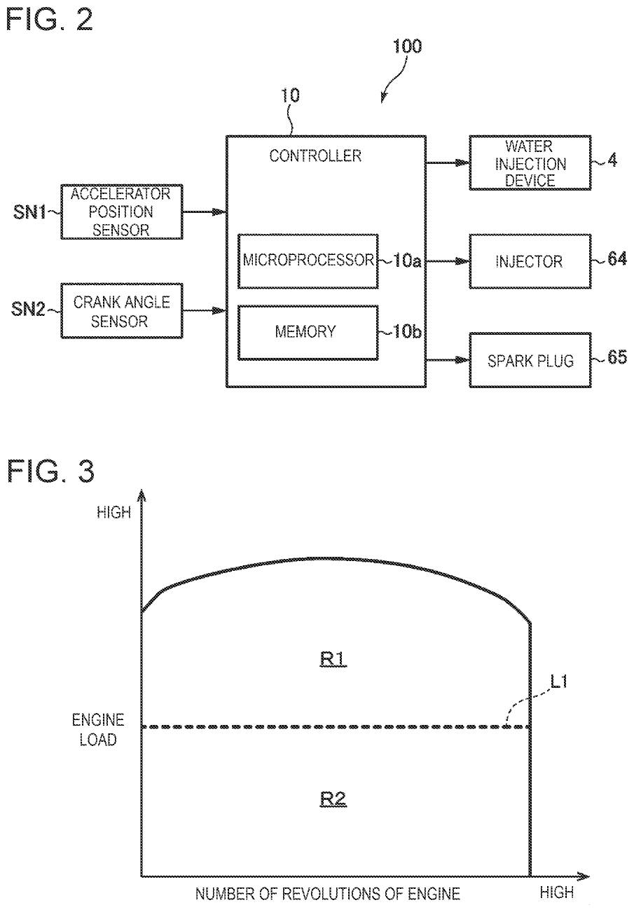

First, the structure of an engine system according to an embodiment of the present invention will be described with reference to FIGS. 1 and 2. FIG. 1 is a schematic structure diagram illustrating the engine system according to the embodiment of the present invention and FIG. 2 is a block diagram illustrating the electric structure of the engine system according to the embodiment of the present invention.

As illustrated in FIG. 1, the engine system 100 according to the embodiment mainly includes an engine 1 that generates power for a vehicle by burning an air-fuel mixture including air and fuel, a water injection device 4 that injects water into the engine 1, and a water supply device 5 that supplies water to the water injection device 4. The engine 1 is a four-stroke reciprocating engine that operates by repeating an intake stroke, a compression stroke, an expansion stroke, and an exhaust stroke in a combustion chamber 11. The engine 1 is mounted on a four-wheeled vehicle. The vehicle travels when the engine 1 operates. The fuel for the engine 1 is gasoline in this structure example. The fuel only needs to be a liquid fuel containing at least gasoline. The fuel may be gasoline containing, for example, bioethanol.

The engine 1 includes a cylinder block 12 and a cylinder head 13 disposed on the cylinder block 12. A plurality of cylinders 14 are formed inside the cylinder block 12. The engine 1 is a multi-cylinder engine. FIG. 1 illustrates only one of the cylinders 14. A piston 3 is inserted into each of the cylinders 14. The piston 3 reciprocates inside the cylinder 14. Although not illustrated, the piston 3 is connected to the crankshaft via a connecting rod. The piston 3 forms the combustion chamber 11 together with the cylinder 14 and the cylinder head 13. The “combustion chamber” means the space formed by the piston 3, the cylinder 14, and the cylinder head 13 regardless of the position of the piston 3.

An intake port 15 is formed for each of cylinders 14 in the cylinder head 13. The intake port 15 communicates with the combustion chamber 11. An intake valve 21 is provided in the intake port 15. The intake valve 21 opens and closes the intake port 15. The intake valve 21 opens and closes by the rotation of a cam 23. It should be noted here that the valve gear that opens and closes the intake valve 21 is a direct-acting type in the illustrated example. The structure of the valve gear of the intake valve 21 is not limited to a specific type.

In addition, an exhaust port 16 is formed for each of the cylinders 14 in the cylinder head 13. The exhaust port 16 also communicates with the combustion chamber 11. An exhaust valve 22 is provided in the exhaust port 16. The exhaust valve 22 opens and closes the exhaust port 16. The exhaust valve 22 opens and closes by the rotation of a cam 24. The valve gear that opens and closes the exhaust valve 22 is a direct acting type in the illustrated example. The structure of the valve gear of the exhaust valve 22 is not limited to a specific type.

An intake pipe 61 is connected to one side (left side in FIG. 1) of the engine 1. The intake pipe 61 communicates with the intake port 15. The gas to be introduced into the combustion chamber 11 flows through the intake pipe 61. Although not illustrated, a throttle valve is provided in the intake pipe 61. An exhaust pipe 62 is connected to the other side (right side in FIG. 1) of the engine 1. The exhaust pipe 62 communicates with the exhaust port 16. The exhaust gas discharged from the combustion chamber 11 flows through the exhaust pipe 62. A catalytic converter 63 is provided in the exhaust pipe 62. The catalytic converter 63 has, for example, a three-way catalyst. The catalytic converter 63 purifies the exhaust gas.

An injector 64 is mounted for each of the cylinders 14 in the cylinder head 13. The injector 64 is provided in the intake port 15. The injector 64 injects fuel into the intake port 15. Although not illustration in detail, the injector 64 is, for example, a multi-injection hole fuel injection valve having a plurality of injection holes. The mount position of the injector 64 illustrated in FIG. 1 is an example. The injector 64 may be provided in the combustion chamber 11 instead of in the intake port 15. That is, the injector 64 may inject fuel directly into the combustion chamber 11.

In addition, although not illustrated in FIG. 1 for convenience of explanation, a spark plug 65 (see FIG. 2) is attached to each cylinder head 13. The spark plug 65 is attached to each of the cylinders 14. In addition, the spark plug 65 is attached to the ceiling portion of the combustion chamber 11. When the spark plug 65 forcibly ignites the air-fuel mixture, the air-fuel mixture undergoes SI (spark ignition) combustion by flame propagation. In the engine 1, an unburned air-fuel mixture may undergo CI (compression ignition) combustion due to self-ignition because the temperature inside the combustion chamber 11 rises due to the heat generated by SI combustion and/or the pressure inside the combustion chamber 11 rises due to flame propagation. That is, the engine 1 may be a compression ignition gasoline engine in which at least part of the air-fuel mixture is burned by compression ignition.

In the other hand, the water supply device 5 heats water and supplies the heated water to the water injection device 4, and the water injection device 4 injects the heated water supplied from the water injection device 4 into the combustion chamber 11 of the engine 1. This engine 1 increases the expansion work due to the vaporization of the heated water by injecting the heated water into the combustion chamber 11 to increase the piston work of the engine 1. In addition, this engine 1 cools the inside of the combustion chamber 11 by injecting the heated water into the combustion chamber 11 to suppress abnormal combustion and improve emissions (reduce NOₓ and CO emissions).

The water injection devices 4 are attached to the cylinder head 13. The water injection device 4 is attached for each of the cylinders 14. The water injection device 4 is attached to the ceiling portion of the combustion chamber 11. The water injection device 4 is disposed substantially midway between the intake side and the exhaust side of the engine 1. In addition, the water injection device 4 is disposed away from the spark plug 65.

The water supply device 5 is connected to the water injection devices 4. The water supply device 5 condenses the water in the exhaust gas and supplies the condensed water to the water injection devices 4. The water supply device 5 includes a condenser 51, a water tank 52, a water pump 53, and a heat exchanger 54. The condenser 51 condenses the water in the exhaust gas taken from the exhaust pipe 62. The condenser 51 is connected to a take-out pipe 55. The take-out pipe 55 connects the exhaust pipe 62 and the condenser 51 to each other. The water tank 52 stores the water condensed by the condenser 51. The water tank 52 is connected to the water injection devices 4 through a first supply pipe 56. The water pump 53 and the heat exchanger 54 are present at a midpoint in the first supply pipe 56. The water pump 53 draws the water in the water tank 52 and discharges the drawn water to the heat exchanger 54. The heat exchanger 54 is attached to the exhaust pipe 62. The heat exchanger 54 exchanges heat between the exhaust gas and the water. The water is heated by the heat of the exhaust gas of the engine 1. The high-temperature and high-pressure water pressurized by the water pump 53 and heated by the heat exchanger 54 is fed to the water injection devices 4. In a preferable example, the heated water at 100° C. or higher and 3 MPa or higher is fed to the water injection devices 4. In a more preferable example, the heated water (corresponding to sub-critical water) at 250° C. or higher and 10 MPa or higher is fed to the water injection devices 4.

In addition, the engine system 100 includes a controller 10 as illustrated in FIG. 2. The controller 10 is a control unit that includes a circuit and is based on a well-known microcomputer. The controller 10 includes one or more microprocessors 10a as a CPU (central processing unit) for executing programs, and memory 10b that includes, for example, RAM (random access memory) and ROM (read only memory) and stores programs and data, an input-output bus through which electric signals are input and output, and the like. For example, the controller 10 includes an ECU (electronic control unit) and the like.

Various sensors are connected to the controller 10. Specifically, an accelerator position sensor SN1 and a crank angle sensor SN2 are mainly connected to the controller 10. The accelerator position sensor SN1 is attached to the accelerator pedal mechanism (not illustrated) and detects the accelerator position corresponding to the operation amount of the accelerator pedal. The crank angle sensor SN2 is attached to the engine 1 and detects the rotation angle of the crankshaft. These sensors SN1 and SN2 output the detection signals corresponding to detection values to the controller 10.

The controller 10 determines the operating state of the engine 1 based on the detection signals of the accelerator position sensor SN1 and the crank angle sensor SN2 and calculates the control amounts of individual devices according to predetermined control logic. The control logic is stored in a memory 10b. The control logic includes calculation of target amounts and/or control amounts using a map stored in the memory 10b. The controller 10 outputs control signals concerning the calculated control amounts to the water injection devices 4, the injector 64, the spark plug 65, and the like. In particular, in the embodiment, the controller 10 controls the water injection devices 4 so as to inject the heated water into the combustion chambers 11 during the compression stroke of the engine 1. In addition, the controller 10 controls a water injection amount and a water injection timing of the water injection devices 4 according to the engine load.

### Water Injection Control

Next, a water injection control performed by the controller 10 in the embodiment of the present invention will be described. First, the basic concept of the water injection control according to the embodiment of the present invention will be described with reference to FIG. 3. In FIG. 3, the horizontal axis represents the number of revolutions of the engine and the vertical axis represents the engine load. In FIG. 3, reference character R1 indicates the first load region in which the engine load is relatively high and reference character R2 indicates the second load region in which the engine load is relatively low.

In the embodiment, the controller 10 first obtains the requested torque to be applied to the vehicle based on the accelerator position detected by the accelerator position sensor SN1, and obtains the requested engine load, which is the load of the engine 1 corresponding to this requested torque. Then, the controller 10 controls the water injection devices 4 so as to make the water injection amount when the requested engine load is in the first load region R1 smaller than the water injection amount when the requested engine load is in the second load region R2, which is lower than the first load region R1. This suppresses abnormal combustion (such as pre-ignition) generated by injecting water into the combustion chamber 11 when the requested engine load is relatively high. That is, in the first load region R1, abnormal combustion is suppressed by reducing the volume of the injected heated water that evaporates and expands due to a temperature rise in the cylinder 14 and suppressing an excessive cylinder pressure rise in the compression stroke.

Here, the first load region R1 and the second load region R2 are defined based on a predetermined value L1 illustrated in FIG. 3. The heated water injected from the water injection device 4 easily causes abnormal combustion when the engine load is equal to or greater than this predetermined value L1. From this point of view, in the first load region R1, the heated water is injected from the water injection device 4 into the combustion chamber 11 in order to mainly cool the air-fuel mixture (so-called end gas) existing in the vicinity of the cylinder liner in the combustion chamber 11 using the injected heated water to suppress knocking caused by this end gas. In contrast, in the second load region R2, the heated water is injected from the water injection device 4 into the combustion chamber 11 in order to mainly improve the engine efficiency through expansion work due to vaporization of the water injected into the combustion chamber 11.

Furthermore, in the embodiment, the controller 10 controls the water injection device 4 so as to make the water injection timing when the requested engine load is in the first load region R1 more advanced than the water injection timing when the requested engine load is in the second load region R2. That is, the controller 10 sets the time to start a water injection from the water injection device 4 in the first load region R1 earlier than in the second load region R2. Typically, the controller 10 injects the heated water in a predetermined period in the early term of the compression stroke in the first load region R1, while the controller 10 injects the heated water in a predetermined period in the later term of the compression stroke or in a predetermined period from the middle term to the later term in the second load region R2. It should be noted here that the early term, the middle term, and the later term of the compression stroke correspond to the three periods obtained by dividing the compression stroke into three equal parts.

As described above, since the heated water injected relatively early in the compression stroke in the first load region R1 appropriately reaches the vicinity of the cylinder liner in the combustion chamber 11, this heated water can suppress the generation of knocking and NOₓ by cooling the air-fuel mixture existing in the vicinity of the cylinder liner (end gas). In addition, since the injected heated water is used for cooling, abnormal combustion due to a cylinder pressure rise caused by the expansion of heated water can also be suppressed.

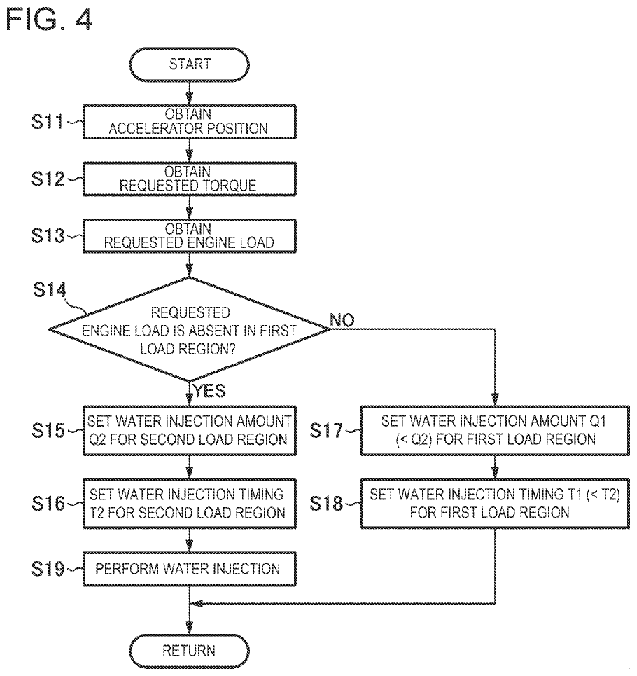

Next, a specific flow of processing in the water injection control according to the embodiment of the present invention will be described with reference to FIG. 4. FIG. 4 is a flowchart illustrating the water injection control of the engine system according to the embodiment of the present invention. This flow is repeatedly executed by the microprocessor 10a in the controller 10 at a predetermined cycle based on a program stored in the memory 10b.

First, in step S11, the controller 10 obtains the accelerator position detected by the accelerator position sensor SN1. Then, in step S12, the controller 10 obtains the requested torque of the driver based on the accelerator position obtained in step S11. For example, the controller 10 determines the requested torque corresponding to the current accelerator position with reference to a map (prepared for various vehicle speeds and gear stages in one example) that defines the requested torque to be applied according to the accelerator position. Then, in step S13, the controller 10 obtains the requested engine load, which is the load of the engine 1 for achieving the requested torque obtained in step S12. The controller 10 obtains the requested engine load by referring to the map in which the torque and the load are associated with each other or performing predetermined calculation for converting the torque into the load.

Then, in step S14, the controller 10 determines whether the requested engine load obtained in step S13 is absent in the first load region R1. As a result, when the requested engine load is absent in the first load region R1 (Yes in step S14), that is, when the requested engine load is present in the second load region R2, the controller 10 proceeds to step S15.

In step S15, the controller 10 sets a water injection amount Q2 for the second load region R2. This water injection amount Q2 is defined in advance from the viewpoint of improving the engine efficiency by expansion work due to vaporization of the heated water injected into the combustion chamber 11 in the second load region R2. In the second load region R2, the water injection amount Q2 does not need to be constant and the water injection amount Q2 may be changed according to the engine load. Specifically, the water injection amount Q2 may be smaller as the engine load is higher.

Then, in step S16, the controller 10 sets a water injection timing T2 (corresponding to the timing at which the water injection from the water injection device 4 is started in the second load region R2) for the second load region R2. This water injection timing T2 is also defined in advance from the viewpoint of improving the engine efficiency by expansion work due to the vaporization of the heated water injected into the combustion chamber 11 in the second load region R2. Typically, a predetermined timing in the middle term or the later term of the compression stroke is applied to water injection timing T2. In the second load region R2, the water injection timing T2 does not need to be constant and the water injection timing T2 may be changed according to the engine load. Specifically, the water injection timing T2 may be more advanced as the engine load is higher.

Then, in step S19, the controller 10 performs control for causing the water injection device 4 to inject the heated water based on the water injection amount Q2 and the water injection timing T2 set in steps S15 and S16, respectively. That is, the controller 10 outputs a control signal to the water injection device 4 so that the water injection is started from the water injection timing T2 during the compression stroke and the water injection amount Q2 is injected.

In contrast, when the requested engine load is present in the first load region R1 (No in step S14), the controller 10 proceeds to step S17. In step S17, the controller 10 sets a water injection amount Q1 for the first load region R1, which is smaller than the water injection amount Q2 for the second load region R2 described above. This water injection amount Q1 is defined in advance from the viewpoint of suppressing knocking and NOₓ by cooling the air-fuel mixture (end gas) existing in the vicinity of the cylinder liner using the heated water injected into the combustion chamber 11 in the first load region R1. In the first load region R1, the water injection amount Q1 does not need to be constant and the water injection amount Q1 may be changed according to the engine load. Specifically, the water injection amount Q1 may be smaller as the engine load is higher. In this case, changes according to the engine load in the water injection amount Q1 applied in the first load region R1 and the water injection amount Q2 applied in the second load region R2 are desirably continuous with each other. That is, the water injection amount is desirably changed continuously according to the engine load across two regions including the first load region R1 and the second load region R2.

Then, in step S18, the controller 10 sets the water injection timing T1 (corresponding to the timing at which the water injection from the water injection device 4 is started in the first load region R1) for the first load region R1, which is more advanced than the water injection timing T2 for the second load region R2 described above. This water injection timing T1 is also defined in advance from the viewpoint of suppressing knocking and NOₓ by cooling the air-fuel mixture (end gas) existing in the vicinity of the cylinder liner using the heated water injected into the combustion chamber 11 in the first load region R1. Typically, predetermined timing in the early term of the compression stroke is applied to the water injection timing T1. In the second load region R2, the water injection timing T2 does not need to be constant and the water injection timing T2 may be changed according to the engine load. Specifically, the water injection timing T2 may be more advanced as the engine load is higher.

Then, in step S19, the controller 10 performs control for causing the water injection device 4 to inject the heated water based on the water injection amount Q1 and the water injection timing T1 set in steps S17 and S18, respectively. That is, the controller 10 outputs a control signal to the water injection device 4 so as to start the water injection from the water injection timing T1 during the compression stroke and inject the water injection amount Q1.

### Operation and Effect

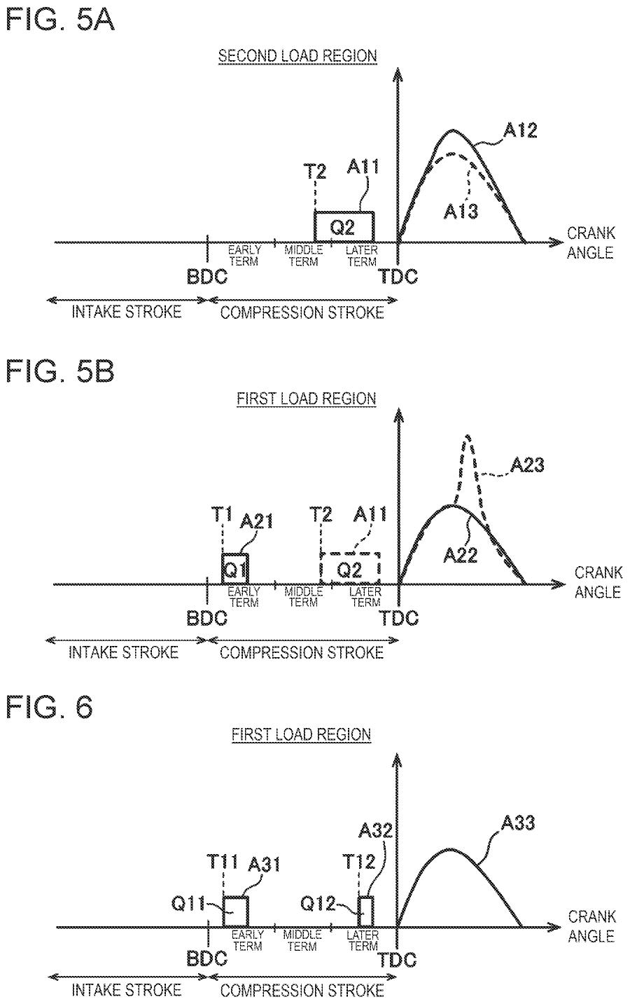

Next, the operation and effect of the water injection control according to the embodiment of the present invention will be explained with reference to FIGS. 5A and 5B. FIG. 5A is a time chart illustrating the water injection control in the second load region R2 according to the embodiment and FIG. 5B is a time chart illustrating the water injection control in the first load region R1 according to the embodiment. In FIGS. 5A and 5B, the horizontal axes represent the crank angle. In addition, FIGS. 5A and 5B schematically illustrate the water injection when the crank angle does not reach the compression TDC (top dead center) and schematically illustrate changes in the cylinder pressure of the engine 1 when the crank angle exceeds the compression TDC (top dead center).

As illustrated in FIG. 5A, in the embodiment, when the requested engine load is in the second load region R2, the controller 10 controls the water injection device 4 so as to start the water injection from the water injection timing T2 in the middle term of compression stroke and inject the water injection amount Q2 that is relatively large (see reference character A11). Here, in FIG. 5A, reference character A12 indicates changes in the cylinder pressure due to the combustion of the air-fuel mixture in the engine 1 when the water injection control described above is performed in the second load region R2, and reference character A13 indicates changes in the cylinder pressure due to combustion of the air-fuel mixture in the engine 1 when the water injection control is not performed. When the injector 64 injects fuel in the intake stroke and the spark plug 65 ignites in the vicinity of the TDC, the air-fuel mixture in the combustion chamber 11 is burned (this is the same in the following). As indicated by reference characters A12 and A13 in FIG. 5A, the cylinder pressure when the water injection control is performed is much larger than the cylinder pressure when the water injection control is not performed. That is, when heated water is injected into the combustion chamber 11 during the compression stroke, the torque of the engine 1 is increased and the engine efficiency is improved by the expansion work due to the vaporization of the heated water.

In contrast, as illustrated in FIG. 5B, in the embodiment, when the requested engine load is in the first load region R1, the controller 10 controls the water injection device 4 so as to start the water injection from the water injection timing T1 (<T2) in the early term of the compression stroke and inject the water injection amount Q1 (<Q2) that is relatively small (see symbol A21). Here, in FIG. 5B, reference character A22 indicates changes in cylinder pressure caused by the combustion of the air-fuel mixture in the engine 1 when the water injection control described above is performed in the first load region R1, and reference character A23 indicates changes in the cylinder pressure caused by the combustion of the air-fuel mixture in the engine 1 when the water injection control similar to that in the second load region R2 is performed in the first load region R1, that is, when the water injection amount Q2 that is relatively large is injected from the water injection timing T2 in the middle term of the compression stroke (see reference character A11). Accordingly, it can be seen that the cylinder pressure rises temporarily (suddenly) when the water injection control similar to that in the second load region R2 is performed, but the cylinder pressure smoothly changes entirely when the water injection control for the first load region R1 is performed. That is, abnormal combustion (such as pre-ignition) occurs when the water injection amount Q2 that is relatively large is injected late in the compression stroke, but the occurrence of abnormal combustion is suppressed when the injection amount Q1 that is relatively small is injected early in the compression stroke.

As described above, according to the embodiment, since the controller 10 sets the water injection amount when the requested engine load is in the first load region R1 smaller than the water injection amount when the requested engine load is in the second load region R2, it is possible to appropriately suppress abnormal combustion generated by injecting the heated water into the combustion chamber 11 when the engine load is relatively high. Specifically, by reducing the water injection amount in the first load region R1, the volume of the injected heated water that evaporates and expands due to a temperature rise in the cylinder 14 is reduced and an excessive cylinder pressure rise in the compression stroke can be suppressed, thereby enabling suppression of abnormal combustion.

In addition, according to the embodiment, the controller 10 sets the water injection timing when the requested engine load is in the first load region R1 more advanced than the water injection timing when the requested engine load is in the second load region R2. The heated water injected relatively early in the compression stroke in the first load region R1 in this way reaches the vicinity of the cylinder liner in the combustion chamber 11 and can cool the air-fuel mixture (end gas) existing in the vicinity of the cylinder liner, thereby enabling suppression of the generation of knocking and NOₓ. In addition, since the injected heated water is used for cooling, abnormal combustion due to a cylinder pressure rise caused by the expansion of heated water can also be suppressed.

### OTHER EMBODIMENTS

Next, other embodiments obtained by modifying the embodiment described above will be described. Although only one water injection is performed during the compression stroke in the first load region R1 in the embodiment described above, a plurality of water injections may be performed in the first load region R1 in another embodiment. In a typical example, two water injections may be performed in the first load region R1.

The water injection control according to another embodiment of the present invention will be described with reference to FIG. 6. In FIG. 6, the horizontal axis represents the crank angle. In addition, FIG. 6 schematically illustrates the water injection when the crank angle does not reach the compression TDC (top dead center) and schematically indicates changes in the cylinder pressure of the engine 1 when the crank angle is after the compression TDC (top dead center).

As illustrated in FIG. 6, in the other embodiment, the controller 10 controls the water injection device 4 so as to perform two injections of the heated water during the compression stroke when the requested engine load is in the first load region R1. Specifically, the controller 10 controls the water injection device 4 so as to inject a water injection amount Q11 (see reference character A31) from a water injection timing T11 in the early term of the compression stroke as the first water injection, and controls the water injection device 4 so as to inject a water injection amount Q12 from a water injection timing T12 in the later term of the compression stroke (see reference character A32) as the second water injection. In this case, the first water injection timing T11 is more advanced than the water injection timing T2 (see FIG. 5) applied in the water injection in the second load region R2 described above, and the first water injection amount Q11 is larger than the second water injection amount Q12.

According to the other embodiment described above, by performing the first water injection relatively early in the compression stroke in the first load region R1 (see reference character A31), the injected water reaches the vicinity of the cylinder liner in the combustion chamber 11 and can cool the air-fuel mixture (end gas) existing in the vicinity of the cylinder liner, thereby enabling suppression of the generation of knocking and NOR. In addition, since the injected heated water is used for cooling, abnormal combustion due to a cylinder pressure rise caused by the expansion of heated water can also be suppressed.

Furthermore, according to the other embodiment, the engine efficiency can be improved by the expansion work due to vaporization of the water injected into the combustion chamber 11 by performing the second water injection relatively late in the compression stroke in the first load region R1 (see reference character A32). In particular, according to the other embodiment, since a relatively small amount of water is injected in the second water injection, it is possible to improve the engine efficiency while suppressing abnormal combustion due to an excessive cylinder pressure rise (see reference character A33).

In addition, according to still another embodiment, three or more water injections may be performed in the first load region R1. In this case, the water injection timing of at least the first water injection of the three or more water injections is desirably more advanced than the water injection timing T2 in the second load region R2. In addition, when three or more water injections are performed, the injection amount of the early water injection is desirably larger than the injection amount of the later water injection. The early water injection refers to the water injection to be performed earlier than the water injection timing T2 applied in the second load region R2 to suppress knocking and the like. In addition, the later water injection refers to the water injection to be performed after the early water injection to improve the engine efficiency, for example, the water injection that is performed concurrently with the water injection timing T2 applied in the second load region R2.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

### DESCRIPTION OF REFERENCE CHARACTERS

1: engine
3: piston
4: water injection device
5: water supply device
10: controller
11: combustion chamber
14: cylinder
51: condenser
52: water tank
53: water pump
54: heat exchanger
62: exhaust pipe
64: injector
65: spark plug
100: engine system
SN1: accelerator position sensor

1. An engine system comprising:
an engine that generates power for a vehicle by burning an air-fuel mixture including air and fuel;
a water injection device that injects heated water into a combustion chamber of the engine;
an accelerator position sensor that detects an accelerator position corresponding to an operation amount of an accelerator pedal of the vehicle; and
a controller configured to control the water injection device so as to inject water into the combustion chamber during a compression stroke of the engine,
wherein the controller:
obtains a requested torque to be applied to the vehicle based on the accelerator position detected by the accelerator position sensor,
obtains a requested engine load that is a load of the engine corresponding to the requested torque, and
controls the water injection device so as to make a water injection amount when the requested engine load is in a first load region smaller than the water injection amount when the requested engine load is in a second load region in which the requested engine load is smaller than in the first load region.

2. The engine system according to claim 1, wherein the controller controls the water injection device so as to make a water injection timing when the requested engine load is in the first load region more advanced than a water injection timing when the requested engine load is in the second load region.

3. The engine system according to claim 1, wherein the controller controls the water injection device so as to perform a plurality of water injections during the compression stroke when the requested engine load is in the first load region.

4. The engine system according to claim 3, wherein the controller controls the water injection device so as to make a timing of at least a first water injection when a plurality of water injections are performed with the requested engine load in the first load region more advanced than a water injection timing when the requested engine load is in the second load region.

5. The engine system according to claim 4, wherein, when the plurality of water injections are performed with the requested engine load in the first load region, the controller controls the water injection device so as to make a water injection amount in a first half injection larger than a water injection amount in a second half injection.

6. The engine system according to claim 5, further comprising:
a heat exchanger that heats water using heat of exhaust gas of the engine, the heat exchanger being provided in an exhaust pipe of the engine,
wherein the water heated by the heat exchanger is supplied to the water injection device.

7. An engine system comprising:
an engine that generates power for a vehicle by burning an air-fuel mixture including air and fuel;
a water injection device that injects heated water into a combustion chamber of the engine;
an accelerator position sensor that detects an accelerator position corresponding to an operation amount of an accelerator pedal of the vehicle; and
a controller configured to control the water injection device so as to inject water into the combustion chamber during a compression stroke of the engine,
wherein the controller:
obtains a requested torque to be applied to the vehicle based on the accelerator position detected by the accelerator position sensor,
obtains a requested engine load that is a load of the engine corresponding to the requested torque, and
controls the water injection device so as to make a water injection amount smaller as the requested engine load is higher.

8. The engine system according to claim 2, further comprising:
a heat exchanger that heats water using heat of exhaust gas of the engine, the heat exchanger being provided in an exhaust pipe of the engine,
wherein the water heated by the heat exchanger is supplied to the water injection device.

9. The engine system according to claim 3, wherein, when the plurality of water injections are performed with the requested engine load in the first load region, the controller controls the water injection device so as to make a water injection amount in a first half injection larger than a water injection amount in a second half injection.

10. The engine system according to claim 3, further comprising:
a heat exchanger that heats water using heat of exhaust gas of the engine, the heat exchanger being provided in an exhaust pipe of the engine,
wherein the water heated by the heat exchanger is supplied to the water injection device.

11. The engine system according to claim 4, further comprising:
a heat exchanger that heats water using heat of exhaust gas of the engine, the heat exchanger being provided in an exhaust pipe of the engine,
wherein the water heated by the heat exchanger is supplied to the water injection device.

12. The engine system according to claim 9, further comprising:
a heat exchanger that heats water using heat of exhaust gas of the engine, the heat exchanger being provided in an exhaust pipe of the engine,
wherein the water heated by the heat exchanger is supplied to the water injection device.

13. The engine system according to claim 2, wherein the controller injects the heated water in a predetermined period in an early term of the compression stroke in the first load region, while the controller injects the heated water in a predetermined period in a later term of the compression stroke or in a predetermined period from the middle term to the later term in the second load region.

14. The engine system according to claim 3, wherein the controller controls the water injection device so as to inject a water injection amount from a water injection timing in an early term of the compression stroke as a first water injection when a plurality of water injections are performed, and controls the water injection device so as to inject a water injection amount from a water injection timing in a later term of the compression stroke as a second water injection.

15. The engine system according to claim 14, wherein the controller controls the water injection device so as to make the timing of at least the first water injection with the requested engine load in the first load region more advanced than a water injection timing when the requested engine load is in the second load region.

16. The engine system according to claim 14, wherein, when the plurality of water injections are performed with the requested engine load in the first load region, the controller controls the water injection device so as to make a water injection amount in a first half injection larger than a water injection amount in a second half injection.

17. The engine system according to claim 15, wherein, when the plurality of water injections are performed with the requested engine load in the first load region, the controller controls the water injection device so as to make a water injection amount in a first half injection larger than a water injection amount in a second half injection.
